(19) United States
(12) Patent Application Publication
(10) Pub. No.: US 2026/0292625 A1
(43) Pub. Date: Sep. 24, 2026

(54) DEVICES AND METHODS FOR COMMUNICATION

(71) Applicant: NEC CORPORATION, Tokyo (JP)

(72) Inventors: Zhen HE, Beijing (CN); Rao SHI, Beijing (CN); Peng GUAN, Beijing (CN); Gang WANG, Beijing (CN)

(73) Assignee: NEC Corporation, Tokyo (JP)

(21) Appl. No.: 19/478,024

(22) PCT Filed: Apr. 25, 2023
(86) PCT No.: PCT/CN2023/090665

§ 371 Date: Oct. 23, 2025

(51) Int. Cl. H04W 36/00

(52) U.S. Cl. CPC H04W 36/008375

(57) ABSTRACT

Embodiments of the present disclosure provide a solution for transmitting information used for data collection. In a solution, a first device determines first information related to a machine learning (ML) model deployed at the first device, where the first information indicates at least one of the following: a first set of candidate cells associated with an output of the ML model, or a second set of candidate cells associated with an input of the ML model; and transmits, the first information to a second device.

### FIELDS

Example embodiments of the present disclosure generally relate to the field of communication techniques and in particular, to devices and methods for transmitting information used for data collection.

### BACKGROUND

As communication networks and services increase in size, complexity, and number of users, operations in the communication networks may become increasingly more complicated. In order to improve the communication performance, machine learning (ML)/artificial intelligence (AI) technology is proposed to be used in the wireless communication network. For example, the terminal device and the network device may use different ML models to assist communication-related functionalities, such as, beam management (BM), mobility management and so on.

In some cases, the ML model is deployed at one communication device, such as a terminal device. In this event, the terminal device may need to collect data for model training inference/update/monitoring. However, the network device does not understand the model training requirements, and thus the network device cannot configure suitable resources to assist the terminal device to collect data.

### SUMMARY

In general, embodiments of the present disclosure provide a solution for transmitting information used for data collection.

In a first aspect, there is provided a first device comprising: a processor configured to cause the first device to: determine, first information related to an ML model deployed at the first device, the first information indicating at least one of the following: a first set of candidate cells associated with an output of the ML model, or a second set of candidate cells associated with an input of the ML model; and transmit, the first information to a second device.

In a second aspect, there is provided a second device comprising: a processor configured to cause the second device to: receive, from a first device deployed with an ML model, first information related to the ML model, the first information indicating at least one of the following: a first set of candidate cells associated with an output of the ML model, or a second set of candidate cells associated with an input of the ML model.

In a third aspect, there is provided a communication method performed by a first device. The method comprises: determining, first information related to an ML model deployed at the first device, the first information indicating at least one of the following: a first set of candidate cells associated with an output of the ML model, or a second set of candidate cells associated with an input of the ML model; and transmitting, the first information to a second device.

In a fourth aspect, there is provided a communication method performed by a second device. The method comprises: receiving, from a first device deployed with an ML model, first information related to the ML model, the first information indicating at least one of the following: a first set of candidate cells associated with an output of the ML model, or a second set of candidate cells associated with an input of the ML model.

In a fifth aspect, there is provided a computer readable medium having instructions stored thereon, the instructions, when executed on at least one processor, causing the at least one processor to carry out the method according to the third, or fourth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1A illustrates an example communication environment in which example embodiments of the present disclosure can be implemented;

FIG. 1B illustrates an example communication environment in which example embodiments of the present disclosure can be implemented;

FIG. 2 illustrates a signaling flow for communicating information about the number of predicted beams in accordance with some embodiments of the present disclosure;

FIG. 3 illustrates an example block of different periods;

FIG. 4 illustrates a flowchart of a method implemented at a first device according to some example embodiments of the present disclosure;

FIG. 5 illustrates a flowchart of a method implemented at a second device according to some example embodiments of the present disclosure; and

FIG. 6 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100A GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As discussed above, in order to improve the communication performance, ML/AI technology is proposed to be used in the wireless communication network. For example, the terminal device and the network device may use different ML models to assist communication-related functionalities, such as, BM, mobility management and so on.

In case of mobility management, some use cases are expected to be supported, such as, target cell prediction with one-sided model (such as, predicting the target cell and predicting when to handover to the target cell), radio resource management (RRM) prediction with one-sided model (such as, predicting future reference signal received power (RSRP)/signal to interference plus noise ratio (SINR), temporal beam prediction of BM, handover parameter optimization (such as, predicting future HO parameters, for example, hysteresis, offset, time to trigger (TTT), cell individual offset (CIO), Timer 304), trajectory (or radio link failure (RLF)/handover failure (HOF) avoidance) prediction with one-sided model (such as, predicting where the coverage hole/obstacle is), temporal or spatial beam prediction across cells with one-sided model (such as, spatial/temporal beam prediction is extended to the beams of multiple cells).

When operating the mobility management prediction, the terminal device may use historical layer1 (L1) measurements (e.g., L1-RSRP, L1-SINR) of beams of candidate cells (and other possible assistance information at the terminal device side) to predict the target cell, or future L1 measurements of beams of candidate cells. That is, the terminal device needs to collect data for model training inference/update/monitoring. However, the network device does not understand the model training requirements, and thus the network device cannot configure suitable resources to assist the terminal device to collect data.

According to the example embodiments of the present discourse, a solution for transmitting information used for data collection is proposed. In this solution, a first device (such as, a terminal device) determines first information related to the ML model deployed at the first device, where the first information indicates at least one of the following: a first set of candidate cells associated with an output of the ML model, or a second set of candidate cells associated with an input of the ML model, Then, the first device transmits the first information to a second device (such as, a network device).

By transmitting the first information to the second device, the second device may allocate reasonable measurement resources for the first device, such that the first device may collect enough data to ensure the ML operates properly.

In the following text, merely for better understanding a terminal device and a network device would be used as examples of the first and second devices. It should be understood that the embodiments described herein may be implemented among any suitable communication device unless there is a clear literal statement. Specifically, any of the first and second device may either a terminal device or a network device.

As used herein, the term “model” is referred to as an association between an input and an output learned from training data, and thus a corresponding output may be generated for a given input after the training. The generation of the model may be based on an ML technique. The ML techniques may also be referred to as AI techniques. In general, an ML model can be built, which receives input information and makes predictions based on the input information.

As used herein, a model may be equivalent to at least one of the following: an AI/ML model, an ML model, an AI model, a data-driven, a data processing model, an algorithm, a functionality, a procedure, a process, an entity, a function, a feature, a feature group, a model ID, a functionality ID, a configuration ID, a scenario ID, a site ID, or a dataset ID. As a result, the above terms may be used interchangeably.

In some embodiments, the model may be represented by or associated with a channel, a resource, a resource set, a RS resource, a RS resource set, a RS port, a set of RS ports, a RS port ID, or a set of RS port IDs.

In some embodiments, the model may comprise a set of weights values that may be learned during training, for example for a specific architecture or configuration, where a set of weights values may also be called a parameter set.

In some embodiments, the model may be used to predict a target cell, or measurements of a set of beams of a set of candidate cells in future based on at least historical measurements (e.g., L1-RSRP, L1-SINR) of a set of beams of a set of candidate cells.

In some embodiments, an input of the ML model (i.e., AI input) may refer to the input of a model and indicate data inputted into the model, which may be equivalent to data.

In some embodiments, an output of ML model (i.e., AI output) may refers to the output of a model and indicate result(s) outputted by the model, which is equivalent to label/data.

In some embodiments, the AI input or output of a model may be the information included in meta information/description associated with the model.

In the present disclosure, a beam may be equivalent to (or represented by) an RS (e.g., a channel state information-reference signal (CSI-RS), a synchronization signal and physical broadcast channel (PBCH) block (SSB)), an RS resource, an associated RS, an associated RS resource, an RS resource indicator (e.g., a CSI-RS resource indicator (CRI), an SSB resource indicator (SSBRI)), an RS index (e.g., CSI-RS-Index, SSB-Index), an associated RS resource indicator, or associated RS index. It also should be understood that in fact, a beam may refer to a resource that enables a spatially directional communication, and thus the beam may be identified by other suitable parameter. In present disclosure is not limited in this regard.

As used herein, data collection may be used for model training, model validating, model testing, model update (e.g., fine-tuning), model inference and/or model monitoring. Alternatively, or in addition, the data collection may refer to a process of collecting data by the network nodes, the management entity, the UE, or the terminal device for the purpose of AI/ML model training, data analytics and inference. Further, data collection may be performed for different purposes in life cycle management (LCM), e.g., model training, model inference, model monitoring, model selection, model update, and so on.

As used herein, terms “measurement quantity” and “beam measurement quantity” may be used interchangeably, including but not limited to, (L1)-RSRP, (L1)-SINR, (L1)-received signal strengthen indicator (RSSI), or (L1)-reference signal received quality (RSRQ). Further, L1-RSRP may be equivalent to RSRP or RSRQ, and L1-SINR may be equivalent to SINR.

As used herein, beam measurement resource may be equivalent to channel measurement resource (CMR) or (and) interference measurement resource (IMR).

As used herein, predict (or prediction) may be equivalent to (model) inference.

As used herein, a cell may be equivalent to (downlink or uplink) bandwidth part (BWP). Further, a cell may be equivalent to (or represented by) at least one of indicator of cell (including but not limited to, a cell ID, a physical cell identity (PCI), an additional PCI, a serving cell index), a cell identity (e.g., Cell-Identity) or indicator or information of frequency. In addition, a cell may be a primary cell (PCell), primary secondary cell (PSCell) or secondary cell (SCell).

As used herein, a serving cell may be equivalent to source cell or intra-frequency cell, and a non-serving cell may be equivalent to neighbor cell or inter-frequency cell. Further, the candidate cell may be a serving cell or non-serving cell.

As used herein, cells within the same frequency range (or band) (associated with the same frequency range/band) may refer to that SSBs of the cells have the same center frequency and sub-carrier space (SCS).

In the context of the present disclosure,
[symbol] terms “time stamp”, “period”, “interval”, “time interval”, “time period”, “gap”, “time gap” and “time of logging data” may be used interchangeably;
[symbol] terms “time instance”, “transmission instant”, “time/transmission unit”, “time/transmission frame”, “time/transmission sub frame”, “time/transmission slot”, “time/transmission symbol”, “time/transmission point”, “time/transmission stamp”, “time/transmission occasion” may be used interchangeably;
[symbol] terms “time/transmission instance”, “time/transmission unit”, “time/transmission instant”, “time/transmission frame”, “time/transmission sub frame”, “time/transmission slot”, “time/transmission sub symbol”, “time/transmission sub point”, “time/transmission sub stamp”, “time/transmission sub occasion” may be used interchangeably;
[symbol] terms “future”, “prediction” and “predicted” may be used interchangeably.

Principles and implementations of the present disclosure will be described in detail below with reference to the figures.

### Example Environment

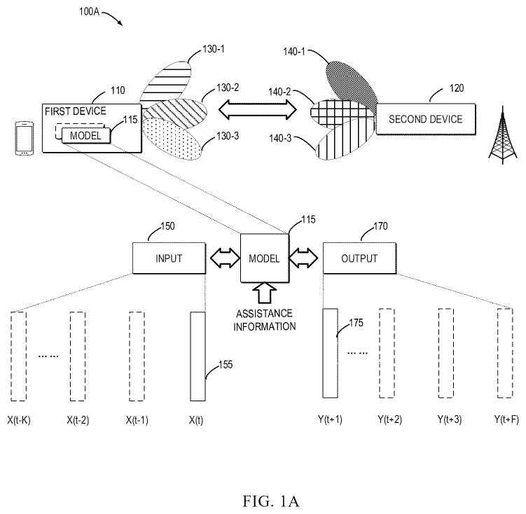

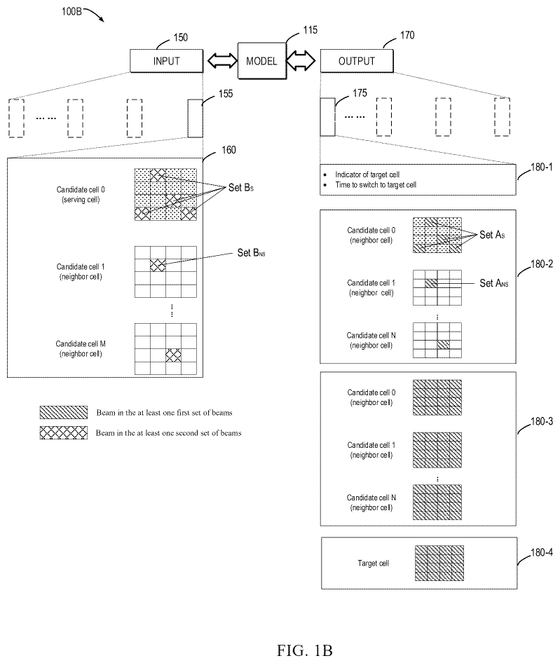

FIG. 1A illustrates a schematic diagram of an example communication environment 100A in which example embodiments of the present disclosure can be implemented. In the communication environment 100A, a plurality of communication devices, including a first device 110 and a second device 120, can communicate with each other.

Further, multiple input multiple output (MIMO) is supported in the communication environment 100A, such that the second device 120 and the first device 110 may communicate with each other via different beams to enable a directional communication.

In the example of FIG. TA, in some embodiments, the first device 110 may include a terminal device and the second device 120 may include a network device serving the terminal device. In this specific example embodiment, a link from the first device 110 to the second device 120 is referred to as uplink, while a link from the second device 120 to the first device 110 is referred to as a downlink.

In downlink, the second device 120 is a transmitting (TX) device (or a transmitter) and the first device 110 is a receiving (RX) device (or a receiver), and the second device 120 may transmit downlink transmission to the first device 110 via one or more beams. As illustrated in FIG. TA, the second device 120 transmits downlink transmission to the first device 110 via the one or more of beams 140-1, 140-2 and 140-3. For purpose of discussion, the beams 140-1 to 140-3 are collectively or individually referred to as beam 140.

Correspondingly, in uplink, the second device 120 is an RX device (or a receiver) and the first device 110 is a TX device (or a transmitter), and the first device 110 may transmit uplink transmission to the second device 120 via one or more beams. As illustrated in FIG. TA, the first device 110 transmits uplink transmission to the second device 120 via the beams 130-1 to 130-3. For purpose of discussion, the beams 130-1 to 130-3 are collectively or individually referred to as beam 130.

It is to be understood that the number of devices and their connections shown in FIG. 1A are only for the purpose of illustration without suggesting any limitation. The communication environment 100A may include any suitable number of devices configured to implementing example embodiments of the present disclosure.

In some embodiments, the first device 110 and the second device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication environment 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, one or more models may be deployed at the first device 110. As illustrated in FIG. 1A, the model 115 is deployed at the first device 110. Further, according to some embodiments of the present disclosure, for the training data collection for the model 115 at the first device 110, training-related information (such as, supported/preferred configurations of resources and/or the number of the needed data samples) may be reported to the second device 120 which may be discussed in the following.

In FIG. 1A, the model 115 may assist mobility management functionality. As illustrated in FIG. 1A, the model 115 may receive input 150 and provide output 170. More details about input 150 and output 170 will be discussed with reference to FIG. 1B.

FIG. 1B illustrates a schematic diagram of an example communication environment 100B in which example embodiments of the present disclosure can be implemented. As illustrated in FIG. 1B, the input 150 includes a set of data samples including data sample 155, where each data sample corresponds to a historical measurement time instance. In some embodiments, data sample 155 may be measurements of sets of beams associated with a set of candidate cells (e.g., L1-RSRP, L1-SINR, L1-RSSI or L1-RSRQ), as illustrated in block 160.

According to some embodiments of the present disclosure, the output 170 may be represented by any suitable. In some embodiments, the output 170 may include a set of data samples including data sample 175.

In some embodiments, the output 170 may be an indicator of target cell and/or a time information indicating the time point to switch to target cell, as illustrated in block 180-1.

In some embodiments, the output 170 may correspond to a set of future time instances. Further, as for each future time instance, there may be a data sample. As illustrated in FIG. 1B, the data sample 175 may be predicted L1-RSRPs/L1-SINRs of sets of beams associated with a set of candidate cells. In some embodiments, the set of candidate cells/the set of beams associated with the output 170 may be the same with the set of candidate cells/the set of beams associated with the input 150, as illustrated in block 180-2.

Alternatively, in some embodiments, the set of candidate cells/the set of beams associated with the output 170 may be the extended set of the set of candidate cells/the set of beams associated with the input 150, as illustrated in block 180-3.

In some embodiments, the data sample 175 may be the predicted L1-RSRPs/L1-SINRs of a set of beams associated with target cell, as illustrated in block 180-4. Further, the data sample 175 may correspond to a future time instance.

As discussed previously, for model training of the model of AI/ML based mobility trained at the first device 110, the first device 110 needs to collect data (including data samples and labels) required for model training based on measurement resources for beams and candidate cells configured by the second device 120.

However, the second device 120 does not know the details of the AI/ML model trained at the first device 110, such as, the candidate cells and beams that need to be measured in the AI input, and candidate cells and beams that can be predicted in the AI output. As a result, the second device 120 does not know how to configure measurement resources for beams and candidate cells required for data collection of the model 115.

According to the example embodiments of the present discourse, a solution for transmitting information used for data collection, especially for data collection of the model 115 applied for ML-based mobility. In this solution, a first device (such as, a terminal device) determines first information related to the ML model 115 deployed at the first device 110, where the first information indicates at least one of the following: a first set of candidate cells associated with an output of the ML model, or a second set of candidate cells associated with an input of the ML model, Then, the first device transmits the first information to a second device 120 (such as, a network device).

In this way, the information related to the ML model 115 deployed at the first device 110 may be transmitted to the second device 120. Thus, the second device 120 may well understand how to configure measurement resources (i.e., measurement resources for beams and candidate cells) for data collection based on the received information.

### Example Processes

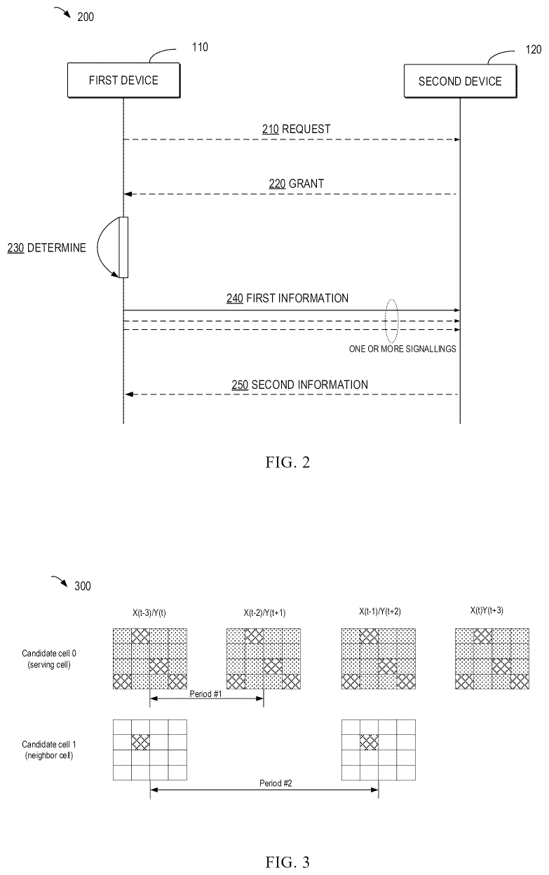

Reference is made to FIG. 2, which illustrates a signaling flow 200 for communicating information about the number of predicted beams in accordance with some embodiments of the present disclosure. For the purposes of discussion, the signaling flow 200 will be discussed with reference to FIG. 1A and FIG. 1B, for example, by using the first device 110 and the second device 120.

It is to be understood that the operations at the first device 110 and the second device 120 should be coordinated. In other words, the second device 120 and the first device 110 should have common understanding about configurations, parameters and so on. Such common understanding may be implemented by any suitable interactions between the second device 120 and the first device 110 or both the second device 120 and the first device 110 applying the same rule/policy. In the following, although some operations are described from a perspective of the first device 110, it is to be understood that the corresponding operations should be performed by the second device 120. Similarly, although some operations are described from a perspective of the second device 120, it is to be understood that the corresponding operations should be performed by the first device 110. Merely for brevity, some of the same or similar contents are omitted here.

In addition, in the following description, some interactions are performed among the first device 110 and the second device 120 (such as, exchanging first and second information and so on). It is to be understood that the interactions may be implemented either in one single signaling/message/configuration or multiple signaling/messages/configurations, including system information, radio resource control (RRC) message, downlink control information (DCI) message, uplink control information (UCI) message, media access control (MAC) control element (CE) and so on. The present disclosure is not limited in this regard.

In some embodiments, the first device 110 may be operated as a terminal device and the second device 120 may be operated as a network device.

In operation, the first device 110 determines 230 first information related to the ML model 115 deployed at the first device 110. In some embodiments, the first information may indicate a first set of candidate cells associated with an output of the ML model 115 (also referred to as Set C in the following). Alternatively, or in addition, in some embodiments, the first information may indicate a second set of candidate cells associated with an input of the ML model 115 (also referred to as Set D in the following). Then, the first device 110 transmits 240 the first information to a second device 120.

In some embodiments, based on the first information, the second device 120 may well understand the measurement requirements for the ML model 115. Then the second device 120 may determine second information indicating measurement resources to be used by the first device 110. After that, the second device 120 may transmit 250 the second information to the first device 110. With the allocated resources, the first device 110 may collect enough data to perform mobility prediction.

In some embodiments, prior to transmitting the first information, the first device 110 may transmit 210 a request for resources used for transmitting the first information to the second device 120. As a result, the second device 120 may transit 220 a grant (such as, an uplink grant) for the request.

In some embodiments, the second set of candidate cells may be a part of the first set of candidate cells. Alternatively, or in addition, in some embodiments, a part of the second set of candidate cells is the same with a part of the first set of candidate cells. Alternatively, or in addition, in some embodiments, the second set of candidate cells is the same with the first set of candidate cells. Alternatively, or in addition, in some embodiments, the second set of candidate cells is different from the first set of candidate cells.

In the following, how to indicate the first set and/or the second set of candidate cells are discussed as below.

In some embodiments, the first information may indicate the first number of candidate cells comprised in the first set of candidate cells and/or the second number of candidate cells comprised in the second set of candidate cells.

In some embodiments, the first number of candidate cells may comprise at least one of the maximum number of candidate cells or the minimum number of candidate cells comprised in the first set of candidate cells supported/allowed by the first device 110 or the ML model 115.

In some embodiments, the second number of candidate cells may comprise at least one of the maximum number of candidate cells or the minimum number of candidate cells comprised in the second set of candidate cells supported/allowed by the first device 110 or the ML model 115.

Alternatively, or in addition, in some embodiments, the first information may indicate a first set of cell identities corresponding to the first set of candidate cells and/or a second set of cell identities corresponding to the second set of candidate cells.

Alternatively, or in addition, in some embodiments, the first information may indicate a union set of the first and second sets of candidate cells and/or the third number of candidate cells comprised in the union set.

Alternatively, or in addition, in some embodiments, the first information may indicate:
[symbol] a first indication indicating whether a serving cell of the first device 110 is comprised in the first set of candidate cells,
[symbol] a second indication indicating whether a serving cell is comprised in the second set of candidate cells,
[symbol] a third indication whether a neighbor cell of the first device 110 is comprised in the first set of candidate cells,
[symbol] a fourth indication whether the neighbor cell is comprised in the second set of candidate cells.

Alternatively, or in addition, in some embodiments, the first information may indicate the first number of neighbor cells comprised in the first set of candidate cells and/or the second number of neighbor cells comprised in the second set of candidate cells.

In some embodiments, the first number of neighbor cells may comprise at least one of the maximum number of neighbor cells or the minimum number of neighbor cells comprised in the first set of candidate cells supported/allowed by the first device 110 or the ML model 115.

In some embodiments, the second number of neighbor cells may comprise at least one of the maximum number of neighbor cells or the minimum number of neighbor cells comprised in the second set of candidate cells supported/allowed by the first device 110 or the ML model 115.

For a better understanding, some example embodiments about how to indicate the candidate cell-related information are discussed as below.

According to the below example embodiments, the second device 120 may understand the number of candidate cells needed to be configured for measurement, and/or the specific candidate cells needed to be configured for measurement.

In some embodiments, the candidate cells may comprise at least one of: the serving cell or one or more non-serving cells (i.e., one or more neighbor cells).

In some embodiments, the first device 110 (such as, a terminal device) may transmit the first information about at least one of: a Set C of candidate cells (i.e., the first set of candidate cells, referred to as “Set C” for short) or a Set D of candidate cells (i.e., the second set of candidate cells, referred to as “Set D” for short) to the second device 120 (such as, a network device). In some embodiments, the Set C of candidate cells may comprise a set of candidate cells corresponding to the AI output, or the AI output derives from the set of candidate cells. In some embodiments, the Set D of candidate cells may comprise a set of candidate cells corresponding to the AI input, i.e., the corresponding measurements (e.g., L1-RSRP) of the Set D are needed to be used as the AI input.

As one embodiment, the AI/ML model may use measurements of Candidate cell 0, 2 and 4 to predict (indicator) of target cell from Candidate cell 0, 1, 2, 3, 4, 5, 6 and 7. In this case, the Set D may comprise Candidate cell 0, 2 and 4, the Set C may comprise Candidate cell 0, 1, 2, 3, 4, 5, 6 and 7.

In some embodiments, the relationship between the Set C and Set D may be: the Set D is the same as the Set C, the Set D is a subset of the Set C, the Set D is different from the Set C, or the Set D is partially overlapped with the Set C.

In some embodiments, the first device 110 may transmit the information (or indication) about at least one of the followings: a size of the Set C or a size of the Set D, where the size of the Set C or Set D indicates the number of candidate cells in the Set C or Set D.

In some embodiments, the size the Set C or Set D may comprise the minimum size or (and) the maximum size, which is supported by the first device 110, or is associated with the ML model 115. In one example, the maximum size of the Set C may indicate that the maximum number of candidate cells that the first device 110 (or the ML model 115) can predict. In another example, the minimum size of the Set D may indicate that the minimum number of candidate cells required/allowed/supported for the first device 110 (or the ML model 115) to predict, i.e., those which are needed to be measured.

Additionally, in some embodiments, considering that the Set D may be the same as, a subset of, or different from the Set C, the first device 110 may transmit the first information about a size of new set of candidate cells to the second device 120, i.e., the first information may indicate the union of the Set C and the Set D.

Additionally, in some embodiments, considering that the candidate cell may be either the serving cell or the non-serving cell and the configuration methods for measurement resources for the serving cell and non-serving may be different, the first device 110 also may transmit at least one of the following first information to the second device 120: indication indicating whether the serving cell is included in the Set C, indication indicating whether the serving cell is included in the Set D, indication indicating whether at least one non-serving cell is included in the Set C or indication indicating whether at least one non-serving cell is included in the Set D.

Additionally, in some embodiments, if at least one non-serving cells is included in the Set C and Set D, the first device 110 may transmit at least one of the following first information to the second device 120: the number of non-serving cells in the Set C, or the number of non-serving cells in the Set D.

In order to enable the second device 120 to know which candidate cells need to be configured, the first device 110 may determine the indicator of candidate cell in the Set C or Set D based on the cell IDs of candidate cells configured by the second device 120. Then the first device 110 may transmit the first information about at least one of the followings to the second device 120: indicator(s) of candidate cell(s) in the Set C, or indicator(s) of candidate cell(s) in the Set D.

In this way, based on the above information transmitted by the first device 110, the second device 120 may know how many (and which) candidate cells need to be configured for measurement. As a result, unnecessary overhead of measurement resources may be saved.

Alternatively, or in addition, in some embodiments, the first information may indicate the beam-related information about the ML model 115.

In some embodiments, the first information may indicate at least one first set of beams associated with the output of the ML model 115 or the first set of candidate cells.

In some embodiments, the at least one first set of beams comprises at least one of the following: a set of beams corresponding to a serving cell comprised in the first set of candidate cells, or a set of beams corresponding to at least one neighbor cell comprised in the first set of candidate cells.

In some embodiments, the first information may indicate the at least one first set of beams by at least one of the following: the first number of beams comprised in the first set of beams and/or a first set of beam identities corresponding to the first set of beams.

In some embodiments, the first number of beams comprises at least one of the maximum number of beams or the minimum number of beams comprised in the first set of beams supported by the first device 110 or the ML model 115.

Alternatively, or in addition, in some embodiments, the first information may indicate at least one second set of beams associated with the input of the ML model 115 or the second set of candidate cells.

In some embodiments, the at least one second set of beams comprises at least one of the following: a set of beams corresponding to the serving cell comprised in the second set of candidate cells, or a set of beams corresponding to at least one neighbor cell comprised in the second set of candidate cells.

In some embodiments, the first information may indicate the second number of beams comprised in the second set of beams, and/or a second set of beam identities corresponding to the second set of beams.

In some embodiments, the second number of beams comprises at least one of the minimum number of beams or the maximum number of beams in the second set of beams supported by the first device 110 or the ML model 115.

Alternatively, or in addition, in some embodiments, the first information may indicate a union set of one or more first sets of beams and one or more second sets of beams.

In some embodiments, beams comprised in the at least one second set of beams may be a part of beams comprised in the at least one first set of beams.

Alternatively, or in addition, in some embodiments, a part of the beams comprised in the at least one second set of beams may be a part of the beams comprised in the at least one first set of beams.

Alternatively, or in addition, in some embodiments, the beams comprised in the at least one second set of beams may be the same with the beams comprised in the at least one first set of beams.

Alternatively, or in addition, in some embodiments, the beams comprised in the at least one second set of beams may be different from the beams comprised in the at least one first set of beams.

For a better understanding, some example embodiments about how to indicate the beam-related information are discussed as below.

In some embodiments, for each candidate cell in the Set C or Set D, the second device 120 needs to understand how many beams do the second device 120 need to configure for measurement and/or which beams do the second device 120 need to configure for measurement.

In some embodiments, as illustrated in FIG. 1B, the first device 110 may transmit the first information about at least one of the following to the second device 120:
[symbol] a Set A_{S} of beams, where the Set A_{S} of beams comprises a set of beams associated with the serving cell, and the AI output corresponds to or derives from these beams the serving cell is included in the Set C); referred to as Set A_{S} for short;
[symbol] a Set A_{NS} of beams, where the Set A_{NS} of beams comprises a set of beams associated with a non-serving cell, and the AI output corresponds to or derives from these beams (if the non-serving cell is included in the Set C); referred to as Set A_{SN} for short;
[symbol] a Set B_{S} of beams, where the Set B_{S} of beams comprises a set of beams associated with the serving cell, and their corresponding measurements (e.g., L1-RSRP) need to be used as the AI input (if the serving cell is included in the Set D; referred to as Set B_{S} for short; or
[symbol] a Set B_{NS} of beams, where the Set B_{NS} of beams comprises a set of beams associated with a non-serving cell, and their corresponding measurements need to be used as the AI input (if the non-serving cell is included in the Set D); referred to as Set B_{NS} for short.

In some embodiments, the first device 110 may transmit the first information (or indication) about at least one of the followings to the second device 120: a size of the Set A_{S}, a size of the Set A_{NS}, a size of the Set B_{S}, a size of the Set B_{NS}. In some embodiments, the size of a set of beams associated with a candidate cell indicates the number of beams in the set of beams associated with the candidate cell.

Additionally, in some embodiments, the size comprises minimum size or (and) maximum size, which is supported by the first device 110, or is associated with the ML model 115. In one embodiment, the maximum size of the Set A_{S} indicates that the maximum number of beams that the first device 110 (or the model) can predict for the serving cell. In another embodiment, the minimum size of the Set B_{S} indicates that the minimum number of beams required for the first device 110 (or the ML model 115) to predict for the serving cell, i.e., those which are needed to be measured for the serving cell.

In some embodiments, considering that the Set B_{S} or Set B_{NS} may be the same as, a subset of or different from the Set A_{S} or Set A_{NS}, the first device 110 may transmit to the second device 120 information about a size of new first set of beams and (or) a size of new second set of beams, wherein the new first set of beams indicates the union of the Set A_{S} and the Set B_{S}, the new second set of beams indicates the union of the Set A_{NS} and the Set B_{NS}.

Additionally, in some embodiments, in order to enable the second device 120 to know which beams need to be configured, the first device 110 may determine the indicator of beam in a set of beams associated with a candidate cell based on IDs of beam measurement resources associated with the candidate cells configured by the second device 120. Then, the first device 110 may transmit to the second device 120 information about at least one of the followings: indicator(s) of beams in the Set A_{S}, indicator(s) of beams in the Set A_{NS}, indicator(s) of beams in the Set B_{S} or indicator(s) of beams in the Set B_{NS}.

In this way, based on the above information transmitted by the first device 110, for each candidate cell that needs to be configured, the second device 120 may know how many (and which) beams need to be configured for measurement. As a result, unnecessary overhead of measurement resources may be saved.

In some embodiments, the first information may indicate a first type of measurement quantity associated with the output of the ML model 115 or the first set of candidate cells.

Alternatively, or in addition, in some embodiments, the first information may indicate a second type of measurement quantity associated with the input of the ML model 115 or the second set of candidate cells.

In some embodiments, the first type of measurement quantity may be associated with one of the following:
[symbol] one or more candidate cells associated with the output of the ML model 115 or comprised in the first set of candidate cells,
[symbol] one or more beams associated with the output of the ML model 115 or comprised in a first set of beams associated with the output of the ML model 115 or the first set of candidate cells,
[symbol] a serving cell associated with the output of the ML model 115 or comprised in the first set of candidate cells, or [symbol] at least one neighbor cell associated with the output of the ML model 115 or comprised in the first set of candidate cells.

In some embodiments, the second type of measurement quantity is associated with one of the following:
[symbol] one or more candidate cells associated with the input of the ML model 115 or comprised in the second set of candidate cells,
[symbol] one or more beams associated with the input of the ML model 115 or comprised in a second set of beams associated with the input of the ML model 115 or the second set of candidate cells,
[symbol] a serving cell associated with the input of the ML model 115 or comprised in the second set of candidate cells, or
[symbol] at least one neighbor cell associated with the input of the ML model 115 or comprised in the second set of candidate cells.

In some embodiments, the first type of measurement quantity or the second type of measurement quantity may be one of the following: RSRP, SINR, RSSI or RSRQ.

In some embodiments, the first information may indicate at least one of the following: whether a first interference of a neighbor cell to a serving cell is needed, whether a second interference of the serving cell to a neighbor cell is needed or whether a third interference of a neighbor cell to another neighbor cell is needed.

In some embodiments, the another neighbor cell may be a default candidate cell, or determined by the first or the second device 120.

Alternatively, or in addition, in some embodiments, the first information may indicate a first amount of the first interference, a second amount of the second interference or a third amount of the third interference.

Alternatively, or in addition, in some embodiments, the first information may indicate cell identities of the candidate cells corresponding to the first interference, identities of the candidate cells corresponding to the second interference, or identities of the candidate cells corresponding to the third interference.

In some embodiments, the first information may indicate the number of candidate cells corresponding to a specific type of measurement quantity.

Alternatively, or in addition, in some embodiments, the first information may indicate cell identities of the candidate cells corresponding to a specific type of measurement quantity.

In some embodiments, the first information may indicate the number of beams corresponding to a specific type of measurement quantity.

Alternatively, or in addition, in some embodiments, the first information may indicate beams identities of the beams corresponding to a specific type of measurement quantity.

For a better understanding, some example embodiments about how to indicate the measurement quantity-related information are discussed as below.

In some embodiments, type of (beam) measurement quantities (e.g., L1-RSRP, L1-SINR) needed in the AI input or (and) AI output will affect the configuration for beam measurement resources. Specifically, if L1-RSRP of the serving cell is needed, the second device 120 only need to configure CMR for the serving cell to measure L1-RSRP. By contrast, if L1-RSRP of the serving cell and L1-SINR between the serving cell and a non-serving cell are needed, the second device 120 may need to configure an IMR associated with the configured CMR to measure L1-SINR between the serving cell and the non-serving cell.

In some embodiments, the first device 110 may transmit information about type of beam measurement quantity (e.g., L1-RSRP, L1-SINR, L1-RSSI, L1-RSRQ) associated with the Set C, Set D, Set A_{S}, Set A_{NS}, Set B_{S} or Set B_{NS}.

In some embodiments, the first device 110 may transmit to the second device 120 the first information (or indication) about at least one of the following types of beam measurement quantity: L1-RSRP, L1-SINR, L1-RSSI and/or L1-RSRQ.

In some embodiments, if the L1-SINR is indicated (or included), the first device 110 may transmit to the second device 120 the first information about at least one of the followings:
[symbol] indication indicating whether the interference of a non-serving cell to the serving cell is required (or needed);
[symbol] indication indicating whether the interference of the serving cell to a non-serving cell is required. In other words, whether the L1-SINR between the serving cell and the non-serving cell is required;
[symbol] indication indicating whether the interference of a non-serving cell to another non-serving cell (e.g., a specific or predefined non-serving cell) is required. In other words, whether the L1-SINR between a non-serving cell and another non-serving cell is required.

In some embodiments, information about indicator of the specific or predefined non-serving cell may be transmitted to the second device 120.

In some embodiments, the first device 110 may transmit to the second device 120 the first information about the number indicating how many measurement quantities (e.g., L1-RSRP, L1-SINR, L1-RSSI, L1-RSRQ) are required.

In some embodiments, if the L1-RSRP (or L1-SINR/L1-RSSI/L1-RSRQ) is indicated, the first device 110 may transmit to the second device 120 information about at least one of the followings: the number indicating how many candidate cells (or non-serving cells) need to be calculated for their corresponding L1-RSRP (or L1-SINR/L1-RSSI/L1-RSRQ), or the number indicating how many beams need to be calculated for their corresponding L1-RSRP (or L1-SINR/L1-RSSI/L1-RSRQ) in a candidate cell.

In some embodiments, the first device 110 may transmit to the second device 120 the first information about indicators of candidate cells (or non-serving cells) that need to be calculated for their corresponding L1-RSRP and (or) indicators of beams that need to be calculated for their corresponding L1-RSRP in a candidate cell.

In some embodiments, if the L1-SINR is indicated, the first device 110 may transmit to the second device 120 information about:
[symbol] the number indicating how many interferences (i.e., interference of a non-serving cell to the serving cell) are required, in other words, how many non-serving cells need to be calculated for the in interference of a non-serving cell to the serving cell;
[symbol] the number indicating how many interferences (i.e., interference of the serving cell to a non-serving cell) are required;
[symbol] P the number indicating how many interferences (i.e., interference of a non-serving cell to another non-serving cell) are required.

In some embodiments, the first device 110 may transmit to the second device 120 information about at least one of the followings:
[symbol] indicators of non-serving cells that need to be calculated for the interference of a non-serving cell to the serving cell;
[symbol] indicators of non-serving cells that need to be calculated for the interference of the serving cell to a non-serving cell;
[symbol] indicators of non-serving cells that need to be calculated for the interference of a non-serving cell to another non-serving cell.

In some embodiments, the above candidate cells belong to the Set C or Set D, the above beams belong to the Set A_{S}, Set A_{NS}, Set B_{S} or Set B_{NS}.

In this way, based on the above first information transmitted by the first device 110, the second device 120 may understand how to configure beam measurement resources required for data collection at the first device 110 side, e.g., channel measurement resource (CMR), interference measurement resource (IMR).

In some embodiments, the first information may indicate at least one period between two adjacent input samples or two adjacent output samples.

In some embodiments, the period may be indicated by one of the following: an absolute value of time length, or a multiple of a specific time length which is one of the following: a default time length, a measurement resource configuration period or a measurement period.

In some embodiments, the at least one period may comprise: a first period corresponding a serving cell of the first device 110, and a second period corresponding at least one neighbor cell of the first device 110.

In some embodiments, the period may be associated with at least one of the following: one or more candidate cells, one or more beams, one or more types of measurement quantity, or one or more types of interference.

For a better understanding, some example embodiments about how to indicate the at least one period are discussed as below.

In some embodiments, the first device 110 may transmit to the second device 120 information about at least one time stamp associated with the Set C, Set D, Set A_{S}, Set A_{NS}, Set B_{S} or Set B_{NS}.

In some embodiments, the time stamp may refer to the time interval between any two measured (or predicted) data samples (continuously in time domain) used as the AI input (or AI output).

In some embodiments, one time stamp may be associated with one candidate cell, or a set of candidate cells, or all candidate cells. In other words, multiple candidate cells may be associated with the same time stamp or different stamps.

Reference is now made to FIG. 3, which illustrates an example block 300 of different periods. In FIG. 3, the at least one time stamp may comprise at least one of a first time stamp (period #1 in FIG. 3) or a second time stamp (period #2 in FIG. 3), wherein the first time stamp is associated with the serving cell and the second time stamp is associated with the non-serving cell(s).

In some embodiments, in addition to candidate cell, the time stamp may be associated with beam or (and) beam measurement quantity (e.g., L1-RSRP, L1-SINR, L1-RSSI, L1-RSRQ). Specifically, one time stamp can be associated with one beam in a candidate cell, or a set of beams in a candidate cell, or all beams in a candidate cell.

In some embodiments, for the time stamp is associated with L1-SINR, the time stamp may be associated with at least one of the followings: the interference of a non-serving cell to the serving cell, the interference of the serving cell to a non-serving cell or the interference of a non-serving cell to another non-serving cell.

In some embodiments, the time stamp may be associated with at least one of candidate cell, beam or a specific (beam) measurement quantity.

In some embodiments, the time stamp may be indicated by a value first device 110 in seconds, milliseconds, frames, sub-frames, slots, or symbols.

In some embodiments, the time stamp may be indicated by a value indicating a multiple of a specific period of time. Additionally, in some embodiments, the specific period of time may be determined based on a period of a beam measurement resource (e.g., periodic/semi-permanent CSI-RS resource, SSB) configured by the second device 120, or a measurement period (for intra-/inter-frequency measurement) configured by the second device 120 (e.g., T_{SSB_measurement_period_intra}, T_{SSB_measurement_period_inter}).

In some embodiments, the above candidate cells belong to the Set C or Set D, and the above beams belong to the Set A_{S}, Set A_{NS}, Set B_{S} or Set B_{NS}.

In this way, based on the above information transmitted by the first device 110, the second device 120 may understand how to configure measurement resources required for data collection at the first device 110 side, e.g., period of the measurement resource.

In some embodiments, the first information may indicate at least one of the following:
[symbol] whether input samples related to intra-frequency are supported by the first device 110 or the ML model 115,
[symbol] whether an intra-frequency is supported for the first set of candidate cells,
[symbol] whether input samples related to inter-frequency are supported by the first device 110 or the ML model 115,
[symbol] whether an inter-frequency is supported for the first set of candidate cells.

Additionally, in addition, in some embodiments, the first information may indicate:
[symbol] whether input samples related to intra-frequency with a specific type of measurement quantity are supported by the first device 110 or the ML model 115,
[symbol] whether an intra-frequency with a specific type of measurement quantity is supported for the first set of candidate cells,
[symbol] whether input samples related to inter-frequency with a specific type of measurement quantity are supported by the first device 110 or the ML model 115,
[symbol] whether an inter-frequency with a specific type of measurement quantity is supported for the first set of candidate cells.

Additionally, in addition, in some embodiments, the first information may indicate:
[symbol] whether output samples related to intra-frequency are supported by the first device 110 or the ML model 115,
[symbol] whether an intra-frequency is supported for the second set of candidate cells,
[symbol] whether output samples related to inter-frequency are supported by the first device 110 or the ML model 115,
[symbol] whether an inter-frequency is supported for the second set of candidate cells.

Additionally, in addition, in some embodiments, the first information may indicate:
[symbol] whether output samples related to intra-frequency with a specific type of measurement quantity are supported by the first device 110 or the ML model 115,
[symbol] whether an intra-frequency with a specific type of measurement quantity is supported for the second set of candidate cells,
[symbol] whether output samples related to inter-frequency with a specific type of measurement quantity are supported by the first device 110 or the ML model 115,
[symbol] whether an inter-frequency with a specific type of measurement quantity is supported for the second set of candidate cells.

Additionally, in addition, in some embodiments, the first information may indicate: the maximum number of candidate cells associated with a same frequency range, or the maximum number of neighbor cells associated with a same frequency range.

For a better understanding, some example embodiments about how to indicate the frequency measurement-related information are discussed as below.

In some embodiments, whether the first device 110 (or the ML model 115) supports intra-frequency measurement (or prediction) or inter-frequency measurement (or prediction) will affect the configuration for measurement resources. Specifically, if the ML model 115 does not support inter-frequency measurement (or prediction) and if the second device 120 configure measurement resources for candidate cells within different frequency ranges, the obviously feasible and reasonable resources allocation is occurred.

In some embodiments, the first device 110 may transmit to the second device 120 the first information about (or indications indicating) at least one of whether intra-frequency is supported for the Set D, whether inter-frequency is supported for the Set D, whether intra-frequency is supported for the Set C, or whether inter-frequency is supported for the Set C.

In some embodiments, “intra-frequency is supported for the Set D” may be equivalent to “intra-frequency measurement is supported”, which means that, a candidate cell (or non-serving cell) applied for the AI input (or measurement) and the serving cell are within the same frequency range.

In some embodiments, “candidate cell applied for the AI input (or AI output)” refers to a candidate cell whose measurements or/and indicator are used as one of the AI input (or whose indicator or/and corresponding predicted measurement quantities are used as one of the AI output).

In some embodiments, “inter-frequency is supported for the Set D” may be equivalent to “inter-frequency measurement is supported” means that, a candidate cell (or non-serving cell) applied for the AI input (or measurement) and the serving cell are within different frequency ranges.

In some embodiments, “intra-frequency is supported for the Set C” may be equivalent to “intra-frequency prediction is supported” means that, a candidate cell (or non-serving cell) applied for the AI output (or prediction) and the serving cell are within the same frequency range.

In some embodiments, “inter-frequency is supported for the Set C” may be equivalent to “inter-frequency prediction is supported” means that, a candidate cell (or non-serving cell) applied for the AI output (or prediction) and the serving cell are within different frequency ranges.

In some embodiments, the first device 110 may transmit to the second device the first information about at least one of the followings:
[symbol] the number indicating how many candidate cells can be within the same frequency range (or different frequency ranges);
[symbol] the number indicating how many non-serving cells can be within the same frequency range as the serving cell (or within different frequency ranges from the serving cell).

In some embodiments, the serving cell or non-serving cell may be a candidate cell applied for the AI input (or AI output).

In some embodiments, the first device 110 may transmit to the second device 120 the first information about at least one of the followings:
[symbol] indication indicating whether frequency L1-RSRP is supported (for the Set D or/and Set C);
[symbol] indication indicating whether inter-frequency L1-RSRP is supported (for the Set D or/and Set C);
[symbol] indication indicating whether frequency L1-SINR is supported (for the Set D or/and Set C);
[symbol] indication indicating whether inter-frequency L1-SINR is supported (for the Set D or/and Set C).

In some embodiments, “frequency L1-RSRP or L1-SINR” means that the candidate cell where the beam measurement resource used to calculate the L1-RSRP or L1-SINR is located (or configured) is within the same frequency range as the serving cell, or is the serving cell.

In some embodiments, “inter-frequency L1-RSRP or L1-SINR” means that the candidate cell where the beam measurement resource used to calculate the L1-RSRP or L1-SINR is located (or configured) is within different frequency range from the serving cell.

In some embodiments, the above candidate cells belong to the Set C or Set D, and the above beams belong to the Set A_{S}, Set A_{NS}, Set B_{S} or Set B_{NS}.

In this way, based on the above information transmitted by the first device 110, the second device 120 may understand how many (and which) candidate cells need to be configured for measurement.

In some embodiments, the first information may be transmitted via at least one of the following: an RRC signalling, a MAC CE, UCI, user assistance information (UAI), a measurement report, a user equipment (UE) radio access capability parameter, or a channel state information (CSI) report.

In one embodiment, the first information may be carried by one or more RRC messages, e.g., UE radio access capability parameter(s), UAI, or a measurement report.

In another embodiment, the first device 110 mat transmit a request (e.g., SR) dedicated (or specified) for data collection. After receiving the request, the second device 120 may schedule uplink resources (e.g., PUCCH/PUSCH resource) to allow the first device 110 to transmit the above first information, wherein the first information may be carried by a MAC CE.

In a further embodiment, the first device 110 may transmit the first information by using a CSI report, which may be included in a UCI.

According to the above procedure, the first information related to an ML model deployed at the first device 110 may be transmitted to the second device 120, the second device 120 may allocate reasonable resources for the first device 110 accordingly, such that the first device 110 may collect data to ensure the ML operates properly.

### Example Methods

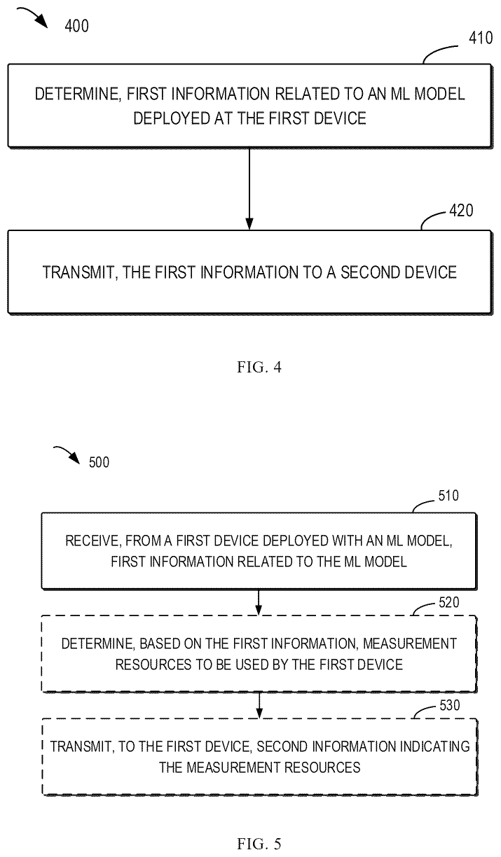

FIG. 4 illustrates a flowchart of a communication method 400 implemented at a first device in accordance with some embodiments of the present disclosure. For the purpose of discussion, the method 400 will be described from the perspective of the first device 110 in FIG. 1A.

At block 410, the first device may determine, first information related to a machine learning (ML) model deployed at the first device, the first information indicating at least one of the following: a first set of candidate cells associated with an output of the ML model, or a second set of candidate cells associated with an input of the ML model.

At block 420, the first device may transmit, the first information to a second device.

In some example embodiments, the second set of candidate cells may be a part of the first set of candidate cells, a part of the second set of candidate cells may be the same with a part of the first set of candidate cells, the second set of candidate cells may be the same with the first set of candidate cells, or the second set of candidate cells may be different from the first set of candidate cells.

In some example embodiments, the first information may indicate at least one of the first and second sets of candidate cells by at least one of the following: the first number of candidate cells comprised in the first set of candidate cells, a first set of cell identities corresponding to the first set of candidate cells, the second number of candidate cells comprised in the second set of candidate cells, a second set of cell identities corresponding to the second set of candidate cells, a union set of the first and second sets of candidate cells, the third number of candidate cells comprised in the union set, a first indication indicating whether a serving cell of the first device is comprised in the first set of candidate cells, a second indication indicating whether a serving cell is comprised in the second set of candidate cells, a third indication whether a neighbor cell of the first device is comprised in the first set of candidate cells, a fourth indication whether the neighbor cell is comprised in the second set of candidate cells, the first number of neighbor cells comprised in the first set of candidate cells, or the second number of neighbor cells comprised in the second set of candidate cells.

In some example embodiments, the first number of candidate cells may comprise at least one of the maximum number of candidate cells or the minimum number of candidate cells comprised in the first set of candidate cells supported by the first device or the ML model, the second number of candidate cells may comprise at least one of the maximum number of candidate cells or the minimum number of candidate cells comprised in the second set of candidate cells supported by the first device or the ML model, the first number of neighbor cells may comprise at least one of the maximum number of neighbor cells or the minimum number of neighbor cells comprised in the first set of candidate cells supported by the first device or the ML model, and the second number of neighbor cells may comprise at least one of the maximum number of neighbor cells or the minimum number of neighbor cells comprised in the second set of candidate cells supported by the first device or the ML model.

In some example embodiments, the first information may further indicate at least one of the following: at least one first set of beams associated with the output of the ML model or the first set of candidate cells, at least one second set of beams associated with the input of the ML model or the second set of candidate cells, or a union set of one or more first sets of beams and one or more second sets of beams.

In some example embodiments, beams comprised in the at least one second set of beams may be a part of beams comprised in the at least one first set of beams, a part of the beams comprised in the at least one second set of beams may be a part of the beams comprised in the at least one first set of beams, the beams comprised in the at least one second set of beams may be the same with the beams comprised in the at least one first set of beams, or the beams comprised in the at least one second set of beams may be different from the beams comprised in the at least one first set of beams.

In some example embodiments, the at least one first set of beams may comprise at least one of the following: a set of beams corresponding to a serving cell comprised in the first set of candidate cells, or a set of beams corresponding to at least one neighbor cell comprised in the first set of candidate cells, and wherein the at least one second set of beams comprises at least one of the following: a set of beams corresponding to the serving cell comprised in the second set of candidate cells, or a set of beams corresponding to at least one neighbor cell comprised in the second set of candidate cells.

In some example embodiments, the first information may be indicated at least one of the first and second sets of beams by at least one of the following: the first number of beams comprised in the first set of beams, a first set of beam identities corresponding to the first set of beams, the second number of beams comprised in the second set of beams, or a second set of beam identities corresponding to the second set of beams.

In some example embodiments, the first number of beams may comprise at least one of the maximum number of beams or the minimum number of beams comprised in the first set of beams supported by the first device or the ML model, and wherein the second number of beams comprises at least one of the minimum number of beams or the maximum number of beams in the second set of beams supported by the first device or the ML model.

In some example embodiments, the first information further may indicate at least one of the following: a first type of measurement quantity associated with the output of the ML model or the first set of candidate cells, or a second type of measurement quantity associated with the input of the ML model or the second set of candidate cells.

In some example embodiments, the first type of measurement quantity may be associated with one of the following: one or more candidate cells associated with the output of the ML model or comprised in the first set of candidate cells, one or more beams associated with the output of the ML model or comprised in a first set of beams associated with the output of the ML model or the first set of candidate cells, a serving cell associated with the output of the ML model or comprised in the first set of candidate cells, or at least one neighbor cell associated with the output of the ML model or comprised in the first set of candidate cells, and wherein the second type of measurement quantity may be associated with one of the following: one or more candidate cells associated with the input of the ML model or comprised in the second set of candidate cells, one or more beams associated with the input of the ML model or comprised in a second set of beams associated with the input of the ML model or the second set of candidate cells, a serving cell associated with the input of the ML model or comprised in the second set of candidate cells, or at least one neighbor cell associated with the input of the ML model or comprised in the second set of candidate cells.

In some example embodiments, the first type of measurement quantity or the second type of measurement quantity may be one of the following: reference signal received power (RSRP), signal to interference plus noise ratio (SINR), received signal strengthen indicator (RSSI), or reference signal received quality (RSRQ).

In some example embodiments, the first information further may indicate at least one of the following: whether a first interference of a neighbor cell to a serving cell is needed, a first amount of the first interference, cell identities of the candidate cells corresponding to the first interference, whether a second interference of the serving cell to a neighbor cell is needed, a second amount of the second interference, identities of the candidate cells corresponding to the second interference, whether a third interference of a neighbor cell to another neighbor cell is needed, a third amount of the third interference, or identities of the candidate cells corresponding to the third interference.

In some example embodiments, the first information further may indicate at least one of the following: the number of candidate cells corresponding to a specific type of measurement quantity, cell identities of the candidate cells corresponding to a specific type of measurement quantity, the number of beams corresponding to a specific type of measurement quantity, or beams identities of the beams corresponding to a specific type of measurement quantity.

In some example embodiments, the first information may further indicate at least one period between two adjacent input samples or two adjacent output samples.

In some example embodiments, the period may be associated with at least one of the following: one or more candidate cells, one or more beams, one or more types of measurement quantity, or one or more types of interference.

In some example embodiments, the at least one period may comprise: a first period corresponding a serving cell of the first device, and a second period corresponding at least one neighbor cell of the first device.

In some example embodiments, the period may be indicated by one of the following: an absolute value of time length, or a multiple of a specific time length which is one of the following: a default time length, a measurement resource configuration period or a measurement period.

In some example embodiments, the first information may further indicate at least one of the following: whether input samples related to intra-frequency are supported by the first device or the ML model, whether an intra-frequency is supported for the first set of candidate cells, whether input samples related to intra-frequency with a specific type of measurement quantity are supported by the first device or the ML model, whether an intra-frequency with a specific type of measurement quantity is supported for the first set of candidate cells, whether input samples related to inter-frequency are supported by the first device or the ML model, whether an inter-frequency is supported for the first set of candidate cells, whether input samples related to inter-frequency with a specific type of measurement quantity are supported by the first device or the ML model, whether an inter-frequency with a specific type of measurement quantity is supported for the first set of candidate cells, whether output samples related to intra-frequency are supported by the first device or the ML model, whether an intra-frequency is supported for the second set of candidate cells, whether output samples related to intra-frequency with a specific type of measurement quantity are supported by the first device or the ML model, whether an intra-frequency with a specific type of measurement quantity is supported for the second set of candidate cells, whether output samples related to inter-frequency are supported by the first device or the ML model, whether an inter-frequency is supported for the second set of candidate cells, whether output samples related to inter-frequency with a specific type of measurement quantity are supported by the first device or the ML model, whether an inter-frequency with a specific type of measurement quantity is supported for the second set of candidate cells, the maximum number of candidate cells associated with a same frequency range, or the maximum number of neighbor cells associated with a same frequency range.

In some example embodiments, the first information may be transmitted via at least one of the following: a radio resource control (RRC) signalling, a medium access control (MAC) control element (CE), uplink control information (UCI), user assistance information (UAI), a measurement report, a user equipment (UE) radio access capability parameter, or a channel state information (CSI) report.

In some example embodiments, the another neighbor cell may be a default candidate cell, or determined by the first or the second device.

In some example embodiments, prior to transmitting the first information, the first device may transmit a request for resources used for transmitting the first information to the second device.

In some example embodiments, the first device may receive, from the second device, second information indicating measurement resources to be used by the first device, the measurement resources are determined by the second device based on the first information.

In some example embodiments, the first device may be a terminal device and the second device may be a network device.

FIG. 5 illustrates a flowchart of a communication method 500 implemented at a second device in accordance with some embodiments of the present disclosure. For the purpose of discussion, the method 500 will be described from the perspective of the second device 120 in FIG. TA.

At block 510, the second device may receive, from a first device deployed with a machine learning (ML) model, first information related to the ML model, the first information indicating at least one of the following: a first set of candidate cells associated with an output of the ML model, or a second set of candidate cells associated with an input of the ML model.

Optionally, at block 520, the second device may determine, based on the first information, measurement resources to be used by the first device.

Optionally, at block 530, the second device may transmit, to the first device, second information indicating the measurement resources.

In some example embodiments, prior to receiving the first information, the second device may receive a request for resources used for transmitting the first information to the second device.

In some example embodiments, the second set of candidate cells may be a part of the first set of candidate cells, a part of the second set of candidate cells may be the same with a part of the first set of candidate cell, the second set of candidate cells may be the same with the first set of candidate cells, or the second set of candidate cells may be different from the first set of candidate cells.

In some example embodiments, the first information may indicate at least one of the first and second sets of candidate cells by at least one of the following: the first number of candidate cells comprised in the first set of candidate cells, a first set of cell identities corresponding to the first set of candidate cells, the second number of candidate cells comprised in the second set of candidate cells, a second set of cell identities corresponding to the second set of candidate cells, a union set of the first and second sets of candidate cells, the third number of candidate cells comprised in the union set, a first indication indicating whether a serving cell of the first device is comprised in the first set of candidate cells, a second indication indicating whether a serving cell is comprised in the second set of candidate cells, a third indication whether a neighbor cell of the first device is comprised in the first set of candidate cells, a fourth indication whether the neighbor cell is comprised in the second set of candidate cells, the first number of neighbor cells comprised in the first set of candidate cells, or the second number of neighbor cells comprised in the second set of candidate cells.

In some example embodiments, the first number of candidate cells may comprise at least one of the maximum number of candidate cells or the minimum number of candidate cells comprised in the first set of candidate cells supported by the first device or the ML model, the second number of candidate cells may comprise at least one of the maximum number of candidate cells or the minimum number of candidate cells comprised in the second set of candidate cells supported by the first device or the ML model, the first number of neighbor cells comprises at least one of the maximum number of neighbor cells or the minimum number of neighbor cells comprised in the first set of candidate cells supported by the first device or the ML model, and the second number of neighbor cells comprises at least one of the maximum number of neighbor cells or the minimum number of neighbor cells comprised in the second set of candidate cells supported by the first device or the ML model.

In some example embodiments, the first information may further indicate at least one of the following: at least one first set of beams associated with the output of the ML model or the first set of candidate cells, at least one second set of beams associated with the input of the ML model or the second set of candidate cells, or a union set of one or more first sets of beams and one or more second sets of beams.

In some example embodiments, beams comprised in the at least one second set of beams may be a part of beams comprised in the at least one first set of beams, a part of the beams comprised in the at least one second set of beams may be a part of the beams comprised in the at least one first set of beams, the beams comprised in the at least one second set of beams may be the same with the beams comprised in the at least one first set of beams, or the beams comprised in the at least one second set of beams may be different from the beams comprised in the at least one first set of beams.

In some example embodiments, the at least one first set of beams may comprise at least one of the following: a set of beams corresponding to a serving cell comprised in the first set of candidate cells, or a set of beams corresponding to at least one neighbor cell comprised in the first set of candidate cells, and wherein the at least one second set of beams may comprise at least one of the following: a set of beams corresponding to the serving cell comprised in the second set of candidate cells, or a set of beams corresponding to at least one neighbor cell comprised in the second set of candidate cells.

In some example embodiments, the first information may indicate at least one of the first and second sets of beams by at least one of the following: the first number of beams comprised in the first set of beams, a first set of beam identities corresponding to the first set of beams, the second number of beams comprised in the second set of beams, or a second set of beam identities corresponding to the second set of beams.

In some example embodiments, the first number of beams may comprise at least one of the maximum number of beams or the minimum number of beams comprised in the first set of beams supported by the first device or the ML model, and wherein the second number of beams comprises at least one of the minimum number of beams or the maximum number of beams in the second set of beams supported by the first device or the ML model.

In some example embodiments, the first information may further indicate at least one of the following: a first type of measurement quantity associated with the output of the ML model or the first set of candidate cells, or a second type of measurement quantity associated with the input of the ML model or the second set of candidate cells.

In some example embodiments, the first type of measurement quantity may be associated with one of the following: one or more candidate cells associated with the output of the ML model or comprised in the first set of candidate cells, one or more beams associated with the output of the ML model or comprised in a first set of beams associated with the output of the ML model or the first set of candidate cells, a serving cell associated with the output of the ML model or comprised in the first set of candidate cells, or at least one neighbor cell associated with the output of the ML model or comprised in the first set of candidate cells, and wherein the second type of measurement quantity is associated with one of the following: one or more candidate cells associated with the input of the ML model or comprised in the second set of candidate cells, one or more beams associated with the input of the ML model or comprised in a second set of beams associated with the input of the ML model or the first set of candidate cells, a serving cell associated with the input of the ML model or comprised in the second set of candidate cells, or at least one neighbor cell associated with the input of the ML model or comprised in the second set of candidate cells.

In some example embodiments, the first type of measurement quantity or the second type of measurement quantity may be one of the following: reference signal received power (RSRP), signal to interference plus noise ratio (SINR), received signal strengthen indicator (RSSI), or reference signal received quality (RSRQ).

In some example embodiments, the first information may further indicate at least one of the following: whether a first interference of a neighbor cell to a serving cell is needed, a first amount of the first interference, cell identities of the candidate cells corresponding to the first interference, whether a second interference of the serving cell to a neighbor cell is needed, a second amount of the second interference, identities of the candidate cells corresponding to the second interference, whether a third interference of a neighbor cell to another neighbor cell is needed, a third amount of the third interference, or identities of the candidate cells corresponding to the third interference.

In some example embodiments, the first information may further indicate at least one of the following: the number of candidate cells corresponding to a specific type of measurement quantity, cell identities of the candidate cells corresponding to a specific type of measurement quantity, the number of beams corresponding to a specific type of measurement quantity, or beams identities of the beams corresponding to a specific type of measurement quantity.

In some example embodiments, the first information may further indicate at least one period between two adjacent input samples or two adjacent output samples.

In some example embodiments, the period may be associated with at least one of the following: one or more candidate cells, one or more beams, one or more types of measurement quantity, or one or more types of interference.

In some example embodiments, the at least one period may comprise: a first period corresponding a serving cell of the first device, and a second period corresponding at least one neighbor cell of the first device.

In some example embodiments, the period may be indicated by one of the following: an absolute value of time length, or a multiple of a specific time length which is one of the following: a default time length, a measurement resource configuration period or a measurement period.

In some example embodiments, the first information may further indicate at least one of the following: whether input samples related to intra-frequency are supported by the first device or the ML model, whether an intra-frequency is supported for the first set of candidate cells, whether input samples related to intra-frequency with a specific type of measurement quantity are supported by the first device or the ML model, whether an intra-frequency with a specific type of measurement quantity is supported for the first set of candidate cells, whether input samples related to inter-frequency are supported by the first device or the ML model, whether an inter-frequency is supported for the first set of candidate cells, whether input samples related to inter-frequency with a specific type of measurement quantity are supported by the first device or the ML model, whether an inter-frequency with a specific type of measurement quantity is supported for the first set of candidate cells, whether output samples related to intra-frequency are supported by the first device or the ML model, whether an intra-frequency is supported for the second set of candidate cells, whether output samples related to intra-frequency with a specific type of measurement quantity are supported by the first device or the ML model, whether an intra-frequency with a specific type of measurement quantity is supported for the second set of candidate cells, whether output samples related to inter-frequency are supported by the first device or the ML model, whether an inter-frequency is supported for the second set of candidate cells, whether output samples related to inter-frequency with a specific type of measurement quantity are supported by the first device or the ML model, whether an inter-frequency with a specific type of measurement quantity is supported for the second set of candidate cells, the maximum number of candidate cells associated with a same frequency range, or the maximum number of neighbor cells associated with a same frequency range.

In some example embodiments, the first information may be transmitted via at least one of the following: a radio resource control (RRC) signalling, a medium access control (MAC) control element (CE), uplink control information (UCI), user assistance information (UAI), a measurement report, a user equipment (UE) radio access capability parameter, or a channel state information (CSI) report.

In some example embodiments, the another neighbor cell may be a default candidate cell, or determined by the first or the second device.

In some example embodiments, the first device may be a terminal device and the second device may be a network device.

### Example Devices and Apparatuses

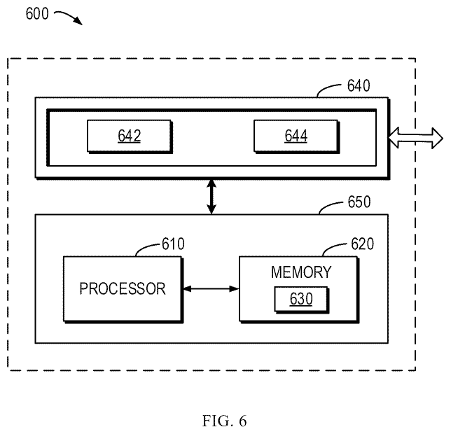

FIG. 6 is a simplified block diagram of a device 600 that is suitable for implementing embodiments of the present disclosure. The device 600 can be considered as a further example implementation of any of the devices as shown in FIG. TA and FIG. 1B. Accordingly, the device 600 can be implemented at or as at least a part of the first device 110 or the second device 120.

As shown, the device 600 includes a processor 610, a memory 620 coupled to the processor 610, a suitable transceiver 640 coupled to the processor 610, and a communication interface coupled to the transceiver 640. The memory 610 stores at least a part of a program 630. The transceiver 640 may be for bidirectional communications or a unidirectional communication based on requirements. The transceiver 640 may include at least one of a transmitter 642 and a receiver 644. The transmitter 642 and the receiver 644 may be functional modules or physical entities. The transceiver 640 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

According to embodiments of the present disclosure, a first device comprising a circuitry is provided. The circuitry is configured to: determine, first information related to a machine learning (ML) model deployed at the first device, the first information indicating at least one of the following: a first set of candidate cells associated with an output of the ML model, or a second set of candidate cells associated with an input of the ML model; and transmit, the first information to a second device. According to embodiments of the present disclosure, the circuitry may be configured to perform any method implemented by the first device as discussed above.

According to embodiments of the present disclosure, a second device comprising a circuitry is provided. The circuitry is configured to: receive, from a first device deployed with a machine learning (ML) model, first information related to the ML model, the first information indicating at least one of the following: a first set of candidate cells associated with an output of the ML model, or a second set of candidate cells associated with an input of the ML model. According to embodiments of the present disclosure, the circuitry may be configured to perform any method implemented by the second device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, it is proposed a first device comprising: a processor configured to cause the first device to: determine, first information related to a machine learning (ML) model deployed at the first device, the first information indicating at least one of the following: a first set of candidate cells associated with an output of the ML model, or a second set of candidate cells associated with an input of the ML model; and transmit, the first information to a second device.

In some embodiments, the second set of candidate cells is a part of the first set of candidate cells, a part of the second set of candidate cells is the same with a part of the first set of candidate cells, the second set of candidate cells is the same with the first set of candidate cells, or the second set of candidate cells is different from the first set of candidate cells.

In some embodiments, the first information indicates at least one of the first and second sets of candidate cells by at least one of the following: the first number of candidate cells comprised in the first set of candidate cells, a first set of cell identities corresponding to the first set of candidate cells, the second number of candidate cells comprised in the second set of candidate cells, a second set of cell identities corresponding to the second set of candidate cells, a union set of the first and second sets of candidate cells, the third number of candidate cells comprised in the union set, a first indication indicating whether a serving cell of the first device is comprised in the first set of candidate cells, a second indication indicating whether a serving cell is comprised in the second set of candidate cells, a third indication whether a neighbor cell of the first device is comprised in the first set of candidate cells, a fourth indication whether the neighbor cell is comprised in the second set of candidate cells, the first number of neighbor cells comprised in the first set of candidate cells, or the second number of neighbor cells comprised in the second set of candidate cells.

In some embodiments, the first number of candidate cells comprises at least one of the maximum number of candidate cells or the minimum number of candidate cells comprised in the first set of candidate cells supported by the first device or the ML model, the second number of candidate cells comprises at least one of the maximum number of candidate cells or the minimum number of candidate cells comprised in the second set of candidate cells supported by the first device or the ML model, the first number of neighbor cells comprises at least one of the maximum number of neighbor cells or the minimum number of neighbor cells comprised in the first set of candidate cells supported by the first device or the ML model, and the second number of neighbor cells comprises at least one of the maximum number of neighbor cells or the minimum number of neighbor cells comprised in the second set of candidate cells supported by the first device or the ML model.

In some embodiments, the first information further indicates at least one of the following: at least one first set of beams associated with the output of the ML model or the first set of candidate cells, at least one second set of beams associated with the input of the ML model or the second set of candidate cells, or a union set of one or more first sets of beams and one or more second sets of beams.

In some embodiments, beams comprised in the at least one second set of beams is a part of beams comprised in the at least one first set of beams, a part of the beams comprised in the at least one second set of beams is a part of the beams comprised in the at least one first set of beams, the beams comprised in the at least one second set of beams is the same with the beams comprised in the at least one first set of beams, or the beams comprised in the at least one second set of beams is different from the beams comprised in the at least one first set of beams.

In some embodiments, the at least one first set of beams comprises at least one of the following: a set of beams corresponding to a serving cell comprised in the first set of candidate cells, or a set of beams corresponding to at least one neighbor cell comprised in the first set of candidate cells, and wherein the at least one second set of beams comprises at least one of the following: a set of beams corresponding to the serving cell comprised in the second set of candidate cells, or a set of beams corresponding to at least one neighbor cell comprised in the second set of candidate cells.

In some embodiments, the first information indicates at least one of the first and second sets of beams by at least one of the following: the first number of beams comprised in the first set of beams, a first set of beam identities corresponding to the first set of beams, the second number of beams comprised in the second set of beams, or a second set of beam identities corresponding to the second set of beams.

In some embodiments, the first number of beams comprises at least one of the maximum number of beams or the minimum number of beams comprised in the first set of beams supported by the first device or the ML model, and wherein the second number of beams comprises at least one of the minimum number of beams or the maximum number of beams in the second set of beams supported by the first device or the ML model.

In some embodiments, the first information further indicates at least one of the following: a first type of measurement quantity associated with the output of the ML model or the first set of candidate cells, or a second type of measurement quantity associated with the input of the ML model or the second set of candidate cells.

In some embodiments, the first type of measurement quantity is associated with one of the following: one or more candidate cells associated with the output of the ML model or comprised in the first set of candidate cells, one or more beams associated with the output of the ML model or comprised in a first set of beams associated with the output of the ML model or the first set of candidate cells, a serving cell associated with the output of the ML model or comprised in the first set of candidate cells, or at least one neighbor cell associated with the output of the ML model or comprised in the first set of candidate cells, and wherein the second type of measurement quantity is associated with one of the following: one or more candidate cells associated with the input of the ML model or comprised in the second set of candidate cells, one or more beams associated with the input of the ML model or comprised in a second set of beams associated with the input of the ML model or the second set of candidate cells, a serving cell associated with the input of the ML model or comprised in the second set of candidate cells, or at least one neighbor cell associated with the input of the ML model or comprised in the second set of candidate cells.

In some embodiments, the first type of measurement quantity or the second type of measurement quantity is one of the following: reference signal received power (RSRP), signal to interference plus noise ratio (SINR), received signal strengthen indicator (RSSI), or reference signal received quality (RSRQ).

In some embodiments, the first information further indicates at least one of the following: whether a first interference of a neighbor cell to a serving cell is needed, a first amount of the first interference, cell identities of the candidate cells corresponding to the first interference, whether a second interference of the serving cell to a neighbor cell is needed, a second amount of the second interference, identities of the candidate cells corresponding to the second interference, whether a third interference of a neighbor cell to another neighbor cell is needed, a third amount of the third interference, or identities of the candidate cells corresponding to the third interference.

In some embodiments, the first information further indicates at least one of the following: the number of candidate cells corresponding to a specific type of measurement quantity, cell identities of the candidate cells corresponding to a specific type of measurement quantity, the number of beams corresponding to a specific type of measurement quantity, or beams identities of the beams corresponding to a specific type of measurement quantity.

In some embodiments, the first information further indicates at least one period between two adjacent input samples or two adjacent output samples.

In some embodiments, the period is associated with at least one of the following: one or more candidate cells, one or more beams, one or more types of measurement quantity, or one or more types of interference.

In some embodiments, the at least one period comprises: a first period corresponding a serving cell of the first device, and a second period corresponding at least one neighbor cell of the first device.

In some embodiments, the period is indicated by one of the following: an absolute value of time length, or a multiple of a specific time length which is one of the following: a default time length, a measurement resource configuration period or a measurement period.

In some embodiments, the first information further indicates at least one of the following: whether input samples related to intra-frequency are supported by the first device or the ML model, whether an intra-frequency is supported for the first set of candidate cells, whether input samples related to intra-frequency with a specific type of measurement quantity are supported by the first device or the ML model, whether an intra-frequency with a specific type of measurement quantity is supported for the first set of candidate cells, whether input samples related to inter-frequency are supported by the first device or the ML model, whether an inter-frequency is supported for the first set of candidate cells, whether input samples related to inter-frequency with a specific type of measurement quantity are supported by the first device or the ML model, whether an inter-frequency with a specific type of measurement quantity is supported for the first set of candidate cells, whether output samples related to intra-frequency are supported by the first device or the ML model, whether an intra-frequency is supported for the second set of candidate cells, whether output samples related to intra-frequency with a specific type of measurement quantity are supported by the first device or the ML model, whether an intra-frequency with a specific type of measurement quantity is supported for the second set of candidate cells, whether output samples related to inter-frequency are supported by the first device or the ML model, whether an inter-frequency is supported for the second set of candidate cells, whether output samples related to inter-frequency with a specific type of measurement quantity are supported by the first device or the ML model, whether an inter-frequency with a specific type of measurement quantity is supported for the second set of candidate cells, the maximum number of candidate cells associated with a same frequency range, or the maximum number of neighbor cells associated with a same frequency range.

In some embodiments, the first information is transmitted via at least one of the following: a radio resource control (RRC) signalling, a medium access control (MAC) control element (CE), uplink control information (UCI), user assistance information (UAI), a measurement report, a user equipment (UE) radio access capability parameter, or a channel state information (CSI) report.

In some embodiments, the another neighbor cell is a default candidate cell, or determined by the first or the second device.

In some embodiments, the processor is further configured to cause the first device to: prior to transmitting the first information, transmit a request for resources used for transmitting the first information to the second device.

In some embodiments, the processor is further configured to cause the first device to: receive, from the second device, second information indicating measurement resources to be used by the first device, the measurement resources are determined by the second device based on the first information.

In some embodiments, the first device is a terminal device and the second device is a network device.

In an aspect, it is proposed a second device comprising: a processor configured to cause the second device to: receive, from a first device deployed with a machine learning (ML) model, first information related to the ML model, the first information indicating at least one of the following: a first set of candidate cells associated with an output of the ML model, or a second set of candidate cells associated with an input of the ML model.

In some embodiments, the second set of candidate cells is a part of the first set of candidate cells, a part of the second set of candidate cells is the same with a part of the first set of candidate cell, the second set of candidate cells is the same with the first set of candidate cells, or the second set of candidate cells is different from the first set of candidate cells.

In some embodiments, the first information indicates at least one of the first and second sets of candidate cells by at least one of the following: the first number of candidate cells comprised in the first set of candidate cells, a first set of cell identities corresponding to the first set of candidate cells, the second number of candidate cells comprised in the second set of candidate cells, a second set of cell identities corresponding to the second set of candidate cells, a union set of the first and second sets of candidate cells, the third number of candidate cells comprised in the union set, a first indication indicating whether a serving cell of the first device is comprised in the first set of candidate cells, a second indication indicating whether a serving cell is comprised in the second set of candidate cells, a third indication whether a neighbor cell of the first device is comprised in the first set of candidate cells, a fourth indication whether the neighbor cell is comprised in the second set of candidate cells, the first number of neighbor cells comprised in the first set of candidate cells, or the second number of neighbor cells comprised in the second set of candidate cells.

In some embodiments, the first number of candidate cells comprises at least one of the maximum number of candidate cells or the minimum number of candidate cells comprised in the first set of candidate cells supported by the first device or the ML model, the second number of candidate cells comprises at least one of the maximum number of candidate cells or the minimum number of candidate cells comprised in the second set of candidate cells supported by the first device or the ML model, the first number of neighbor cells comprises at least one of the maximum number of neighbor cells or the minimum number of neighbor cells comprised in the first set of candidate cells supported by the first device or the ML model, and the second number of neighbor cells comprises at least one of the maximum number of neighbor cells or the minimum number of neighbor cells comprised in the second set of candidate cells supported by the first device or the ML model.

In some embodiments, the first information further indicates at least one of the following: at least one first set of beams associated with the output of the ML model or the first set of candidate cells, at least one second set of beams associated with the input of the ML model or the second set of candidate cells, or a union set of one or more first sets of beams and one or more second sets of beams.

In some embodiments, beams comprised in the at least one second set of beams is a part of beams comprised in the at least one first set of beams, a part of the beams comprised in the at least one second set of beams is a part of the beams comprised in the at least one first set of beams, the beams comprised in the at least one second set of beams is the same with the beams comprised in the at least one first set of beams, or the beams comprised in the at least one second set of beams is different from the beams comprised in the at least one first set of beams.

In some embodiments, the at least one first set of beams comprises at least one of the following: a set of beams corresponding to a serving cell comprised in the first set of candidate cells, or a set of beams corresponding to at least one neighbor cell comprised in the first set of candidate cells, and wherein the at least one second set of beams comprises at least one of the following: a set of beams corresponding to the serving cell comprised in the second set of candidate cells, or a set of beams corresponding to at least one neighbor cell comprised in the second set of candidate cells.

In some embodiments, the first information indicates at least one of the first and second sets of beams by at least one of the following: the first number of beams comprised in the first set of beams, a first set of beam identities corresponding to the first set of beams, the second number of beams comprised in the second set of beams, or a second set of beam identities corresponding to the second set of beams.

In some embodiments, the first number of beams comprises at least one of the maximum number of beams or the minimum number of beams comprised in the first set of beams supported by the first device or the ML model, and wherein the second number of beams comprises at least one of the minimum number of beams or the maximum number of beams in the second set of beams supported by the first device or the ML model.

In some embodiments, the first information further indicates at least one of the following: a first type of measurement quantity associated with the output of the ML model or the first set of candidate cells, or a second type of measurement quantity associated with the input of the ML model or the second set of candidate cells.

In some embodiments, the first type of measurement quantity is associated with one of the following: one or more candidate cells associated with the output of the ML model or comprised in the first set of candidate cells, one or more beams associated with the output of the ML model or comprised in a first set of beams associated with the output of the ML model or the first set of candidate cells, a serving cell associated with the output of the ML model or comprised in the first set of candidate cells, or at least one neighbor cell associated with the output of the ML model or comprised in the first set of candidate cells, and wherein the second type of measurement quantity is associated with one of the following: one or more candidate cells associated with the input of the ML model or comprised in the second set of candidate cells, one or more beams associated with the input of the ML model or comprised in a second set of beams associated with the input of the ML model or the first set of candidate cells, a serving cell associated with the input of the ML model or comprised in the second set of candidate cells, or at least one neighbor cell associated with the input of the ML model or comprised in the second set of candidate cells.

In some embodiments, the first type of measurement quantity or the second type of measurement quantity is one of the following: reference signal received power (RSRP), signal to interference plus noise ratio (SINR), received signal strengthen indicator (RSSI), or reference signal received quality (RSRQ).

In some embodiments, the first information further indicates at least one of the following: whether a first interference of a neighbor cell to a serving cell is needed, a first amount of the first interference, cell identities of the candidate cells corresponding to the first interference, whether a second interference of the serving cell to a neighbor cell is needed, a second amount of the second interference, identities of the candidate cells corresponding to the second interference, whether a third interference of a neighbor cell to another neighbor cell is needed, a third amount of the third interference, or identities of the candidate cells corresponding to the third interference.

In some embodiments, the first information further indicates at least one of the following: the number of candidate cells corresponding to a specific type of measurement quantity, cell identities of the candidate cells corresponding to a specific type of measurement quantity, the number of beams corresponding to a specific type of measurement quantity, or beams identities of the beams corresponding to a specific type of measurement quantity.

In some embodiments, the first information further indicates at least one period between two adjacent input samples or two adjacent output samples.

In some embodiments, the period is associated with at least one of the following: one or more candidate cells, one or more beams, one or more types of measurement quantity, or one or more types of interference.

In some embodiments, the at least one period comprises: a first period corresponding a serving cell of the first device, and a second period corresponding at least one neighbor cell of the first device.

In some embodiments, the period is indicated by one of the following: an absolute value of time length, or a multiple of a specific time length which is one of the following: a default time length, a measurement resource configuration period or a measurement period.

In some embodiments, the first information further indicates at least one of the following: whether input samples related to intra-frequency are supported by the first device or the ML model, whether an intra-frequency is supported for the first set of candidate cells, whether input samples related to intra-frequency with a specific type of measurement quantity are supported by the first device or the ML model, whether an intra-frequency with a specific type of measurement quantity is supported for the first set of candidate cells, whether input samples related to inter-frequency are supported by the first device or the ML model, whether an inter-frequency is supported for the first set of candidate cells, whether input samples related to inter-frequency with a specific type of measurement quantity are supported by the first device or the ML model, whether an inter-frequency with a specific type of measurement quantity is supported for the first set of candidate cells, whether output samples related to intra-frequency are supported by the first device or the ML model, whether an intra-frequency is supported for the second set of candidate cells, whether output samples related to intra-frequency with a specific type of measurement quantity are supported by the first device or the ML model, whether an intra-frequency with a specific type of measurement quantity is supported for the second set of candidate cells, whether output samples related to inter-frequency are supported by the first device or the ML model, whether an inter-frequency is supported for the second set of candidate cells, whether output samples related to inter-frequency with a specific type of measurement quantity are supported by the first device or the ML model, whether an inter-frequency with a specific type of measurement quantity is supported for the second set of candidate cells, the maximum number of candidate cells associated with a same frequency range, or the maximum number of neighbor cells associated with a same frequency range.

In some embodiments, the first information is transmitted via at least one of the following: a radio resource control (RRC) signalling, a medium access control (MAC) control element (CE), uplink control information (UCI), user assistance information (UAI), a measurement report, a user equipment (UE) radio access capability parameter, or a channel state information (CSI) report.

In some embodiments, the another neighbor cell is a default candidate cell, or determined by the first or the second device.

In some embodiments, the processor is further configured to cause the second device to: prior to receiving the first information, receive a request for resources used for transmitting the first information to the second device.

In some embodiments, the processor is further configured to cause the second device to: determine, based on the first information, measurement resources to be used by the first device; and transmit, to the first device, second information indicating the measurement resources.

In some embodiments, the first device is a terminal device and the second device is a network device.

In an aspect, a first device comprises: at least one processor; and at least one memory coupled to the at least one processor and storing instructions thereon, the instructions, when executed by the at least one processor, causing the device to perform the method implemented by the first device discussed above.

In an aspect, a second device comprises: at least one processor; and at least one memory coupled to the at least one processor and storing instructions thereon, the instructions, when executed by the at least one processor, causing the device to perform the method implemented by the second device discussed above.

In an aspect, a computer readable medium having instructions stored thereon, the instructions, when executed on at least one processor, causing the at least one processor to perform the method implemented by the first device discussed above.

In an aspect, a computer readable medium having instructions stored thereon, the instructions, when executed on at least one processor, causing the at least one processor to perform the method implemented by the second device discussed above.

In an aspect, a computer program comprising instructions, the instructions, when executed on at least one processor, causing the at least one processor to perform the method implemented by the first device discussed above.

In an aspect, a computer program comprising instructions, the instructions, when executed on at least one processor, causing the at least one processor to perform the method implemented by the second device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
a processor configured to cause the first device to:
determine, first information related to a machine learning (ML) model deployed at the first device, the first information indicating at least one of the following:
a first set of candidate cells associated with an output of the ML model, or
a second set of candidate cells associated with an input of the ML model; and
transmit, the first information to a second device.

2. The first device of claim 1, wherein,
the second set of candidate cells is a part of the first set of candidate cells,
a part of the second set of candidate cells is the same with a part of the first set of candidate cells,
the second set of candidate cells is the same with the first set of candidate cells, or
the second set of candidate cells is different from the first set of candidate cells.

3. The first device of claim 1 or 2, wherein the first information indicates at least one of the first and second sets of candidate cells by at least one of the following:
the first number of candidate cells comprised in the first set of candidate cells,
a first set of cell identities corresponding to the first set of candidate cells,
the second number of candidate cells comprised in the second set of candidate cells,
a second set of cell identities corresponding to the second set of candidate cells,
a union set of the first and second sets of candidate cells,
the third number of candidate cells comprised in the union set,
a first indication indicating whether a serving cell of the first device is comprised in the first set of candidate cells,
a second indication indicating whether a serving cell is comprised in the second set of candidate cells,
a third indication whether a neighbor cell of the first device is comprised in the first set of candidate cells,
a fourth indication whether the neighbor cell is comprised in the second set of candidate cells,
the first number of neighbor cells comprised in the first set of candidate cells, or the second number of neighbor cells comprised in the second set of candidate cells.

4. The first device of claim 3, wherein the first number of candidate cells comprises at least one of the maximum number of candidate cells or the minimum number of candidate cells comprised in the first set of candidate cells supported by the first device or the ML model,
the second number of candidate cells comprises at least one of the maximum number of candidate cells or the minimum number of candidate cells comprised in the second set of candidate cells supported by the first device or the ML model,
the first number of neighbor cells comprises at least one of the maximum number of neighbor cells or the minimum number of neighbor cells comprised in the first set of candidate cells supported by the first device or the ML model,
and the second number of neighbor cells comprises at least one of the maximum number of neighbor cells or the minimum number of neighbor cells comprised in the second set of candidate cells supported by the first device or the ML model.

5. The first device of any of claims 1 to 4, wherein the first information further indicates at least one of the following:
at least one first set of beams associated with the output of the ML model or the first set of candidate cells,
at least one second set of beams associated with the input of the ML model or the second set of candidate cells, or
a union set of one or more first sets of beams and one or more second sets of beams.

6. The first device of claim 5, wherein,
beams comprised in the at least one second set of beams is a part of beams comprised in the at least one first set of beams,
a part of the beams comprised in the at least one second set of beams is a part of the beams comprised in the at least one first set of beams,
the beams comprised in the at least one second set of beams is the same with the beams comprised in the at least one first set of beams, or
the beams comprised in the at least one second set of beams is different from the beams comprised in the at least one first set of beams.

7. The first device of claim 5 or 6, wherein the at least one first set of beams comprises at least one of the following:
a set of beams corresponding to a serving cell comprised in the first set of candidate cells, or
a set of beams corresponding to at least one neighbor cell comprised in the first set of candidate cells,
and wherein the at least one second set of beams comprises at least one of the following:
a set of beams corresponding to the serving cell comprised in the second set of candidate cells, or
a set of beams corresponding to at least one neighbor cell comprised in the second set of candidate cells.

8. The first device of any of claims 5 to 7, wherein the first information indicates at least one of the first and second sets of beams by at least one of the following:
the first number of beams comprised in the first set of beams,
a first set of beam identities corresponding to the first set of beams,
the second number of beams comprised in the second set of beams, or
a second set of beam identities corresponding to the second set of beams.

9. The first device of claim 8, wherein the first number of beams comprises at least one of the maximum number of beams or the minimum number of beams comprised in the first set of beams supported by the first device or the ML model,
and wherein the second number of beams comprises at least one of the minimum number of beams or the maximum number of beams in the second set of beams supported by the first device or the ML model.

10. The first device of any of claims 1 to 9, wherein the first information further indicates at least one of the following:
a first type of measurement quantity associated with the output of the ML model or the first set of candidate cells, or
a second type of measurement quantity associated with the input of the ML model or the second set of candidate cells.

11. The first device of claim 10, wherein the first type of measurement quantity is associated with one of the following:
one or more candidate cells associated with the output of the ML model or comprised in the first set of candidate cells,
one or more beams associated with the output of the ML model or comprised in a first set of beams associated with the output of the ML model or the first set of candidate cells,
a serving cell associated with the output of the ML model or comprised in the first set of candidate cells, or
at least one neighbor cell associated with the output of the ML model or comprised in the first set of candidate cells,
and wherein the second type of measurement quantity is associated with one of the following:
one or more candidate cells associated with the input of the ML model or comprised in the second set of candidate cells,
one or more beams associated with the input of the ML model or comprised in a second set of beams associated with the input of the ML model or the second set of candidate cells,
a serving cell associated with the input of the ML model or comprised in the second set of candidate cells, or
at least one neighbor cell associated with the input of the ML model or comprised in the second set of candidate cells.

12. The first device of claim 11, wherein the first type of measurement quantity or the second type of measurement quantity is one of the following:
reference signal received power (RSRP),
signal to interference plus noise ratio (SINR),
received signal strengthen indicator (RSSI), or
reference signal received quality (RSRQ).

13. The first device of any of claims 1 to 12, wherein the first information further indicates at least one of the following:
whether a first interference of a neighbor cell to a serving cell is needed,
a first amount of the first interference,
cell identities of the candidate cells corresponding to the first interference,
whether a second interference of the serving cell to a neighbor cell is needed,
a second amount of the second interference,
identities of the candidate cells corresponding to the second interference,
whether a third interference of a neighbor cell to another neighbor cell is needed,
a third amount of the third interference, or
identities of the candidate cells corresponding to the third interference.

14. The first device of any of claims 1 to 13, wherein the first information further indicates at least one of the following:
the number of candidate cells corresponding to a specific type of measurement quantity,
cell identities of the candidate cells corresponding to a specific type of measurement quantity,
the number of beams corresponding to a specific type of measurement quantity, or
beams identities of the beams corresponding to a specific type of measurement quantity.

15. The first device of any of claims 1 to 14, wherein the first information further indicates at least one period between two adjacent input samples or two adjacent output samples.

16. The first device of claim 15, wherein the period is associated with at least one of the following:
one or more candidate cells,
one or more beams,
one or more types of measurement quantity, or
one or more types of interference.

17. The first device of claim 15, wherein the at least one period comprises:
a first period corresponding a serving cell of the first device, and
a second period corresponding at least one neighbor cell of the first device.

18. The first device of any of claims 15 to 17, wherein the period is indicated by one of the following:
an absolute value of time length, or
a multiple of a specific time length which is one of the following: a default time length, a measurement resource configuration period or a measurement period.

19. The first device of any of claims 1 to 18, the first information further indicates at least one of the following:
whether input samples related to intra-frequency are supported by the first device or the ML model,
whether an intra-frequency is supported for the first set of candidate cells,
whether input samples related to intra-frequency with a specific type of measurement quantity are supported by the first device or the ML model,
whether an intra-frequency with a specific type of measurement quantity is supported for the first set of candidate cells,
whether input samples related to inter-frequency are supported by the first device or the ML model,
whether an inter-frequency is supported for the first set of candidate cells,
whether input samples related to inter-frequency with a specific type of measurement quantity are supported by the first device or the ML model,
whether an inter-frequency with a specific type of measurement quantity is supported for the first set of candidate cells,
whether output samples related to intra-frequency are supported by the first device or the ML model,
whether an intra-frequency is supported for the second set of candidate cells,
whether output samples related to intra-frequency with a specific type of measurement quantity are supported by the first device or the ML model,
whether an intra-frequency with a specific type of measurement quantity is supported for the second set of candidate cells,
whether output samples related to inter-frequency are supported by the first device or the ML model,
whether an inter-frequency is supported for the second set of candidate cells,
whether output samples related to inter-frequency with a specific type of measurement quantity are supported by the first device or the ML model,
whether an inter-frequency with a specific type of measurement quantity is supported for the second set of candidate cells,
the maximum number of candidate cells associated with a same frequency range, or
the maximum number of neighbor cells associated with a same frequency range.

20. The first device of any of claims 1 to 19, wherein the first information is transmitted via at least one of the following:
a radio resource control (RRC) signalling,
a medium access control (MAC) control element (CE),
uplink control information (UCI),
user assistance information (UAI),
a measurement report,
a user equipment (UE) radio access capability parameter, or
a channel state information (CSI) report.
